(19) United States
(12) Patent Application Publication
(10) Pub. No.: US 2005/0211507 A1
(43) Pub. Date: Sep. 29, 2005

(54) Method for ensuring and measuring the internal tension of an elevator hoisting rope, and elevator permitting the use of said method

(76) Inventors: Jorma Mustalahti, Hyvinkaa (FI); Esko Aulanko, Kerava (FI)

Correspondence Address: HARNESS, DICKEY & PIERCE, P.L.C., P.O. BOX 8910, RESTON, VA, 20195, US

(21) Appl. No.: 11/121,980

(22) Filed: May 5, 2005

Related U.S. Application Data
(63) Continuation of application No. PCT/FI03/00756, filed on Oct. 13, 2003.

(30) Foreign Application Priority Data
Nov. 15, 2002 (FI) 20022040

(51) Int. Cl. B66B 11/08

(52) U.S. Cl. 187/411

(57) ABSTRACT

The invention also relates to a method for ensuring the internal tightness of an elevator hoisting rope (9) in an elevator provided with hoisting ropes (9). According to the method, each hoisting rope (9) is tightened after installation of the elevator to a desired tightness by twisting the rope by the required number of turns in the twisting direction of the braiding, in such manner that the first end of the rope (9) remains fastened to its anchorage while the second end of the rope is free so as to allow tightening.

The present invention relates to a method as defined in the preamble of claim 1 for ensuring the internal tightness of an elevator hoisting rope and to an elevator as defined in claim 9.

In the use of hoisting ropes, and especially thin elevator hoisting ropes provided with a steel core, it is important to make sure that the mutual tightness of the strands of the hoisting rope is correct after installation and remains as correct as possible during operation of the elevator. The internal tension of the rope may change during installation of the elevator in connection with the handling of the rope. Any loosening between the strands that has started at installation time may accumulate in a given portion of the rope in the longitudinal direction of the rope during operation of the elevator. Such a portion may be e.g. the stretch between the traction sheave and the suspension point in the ceiling if the originally loosened part was in this rope portion. When the rope is twisted in the loosening direction relative to its braid structure, the braiding of the strands forming the rope sheath is opened and the braid structure holding the rope in shape becomes loose, with the result that the interlock between strands is loosened and the contact of the strands with each other is diminished. In consequence, the length of the rope sheath, i.e. the outermost layer of the rope, is increased along the length of the rope, and so the load of the rope is shifted to the straight core strand. Such internal loosening of the rope is a definite risk factor, which may cause serious damage to the hoisting rope.

The object of the present invention is to overcome the above-mentioned drawbacks and to provide a dependable, reliable, easy-to-implement and fast method for ensuring and measuring a sufficient tightness of an elevator hoisting rope, and thus to reduce the risk the hoisting ropes being damaged in connection with elevator operation, thereby also improving the operational dependability, reliability and safety of the elevator.

A further object of the invention is to achieve an elevator with re-tightened hoisting ropes.

The method of the invention for ensuring and measuring the internal tightness of an elevator hoisting rope is characterized by what is disclosed in the characterization part of claim 1. The elevator of the invention is characterized by what is disclosed in the characterization part of claim 9. Other embodiments of the invention are characterized by what is disclosed in the other claims.

By applying the invention, one or more of the following advantages, among others, can be achieved:
reliability of the hoisting rope is improved because a desired internal tightness can be achieved and maintained
operational dependability and reliability of the elevator is improved because damage due to internal loosening of the rope is avoided
a sufficient internal tightness keeps the rope sheath well in shape, allowing a good and uniform friction to be achieved between the rope and the rope groove over the entire length of the rope
the invention makes it possible to reduce elevator installation times and the total installation costs because the tightening method and the measurement of tightness are fast and easy to carry out.

A primary area of application of the invention is elevators designed for freight/passenger transportation. Another primary area of application is in elevators having relatively thin twisted hoisting ropes provided with a steel core.

In the following, the invention will be described in detail by means of an example with reference to the attached drawings, wherein

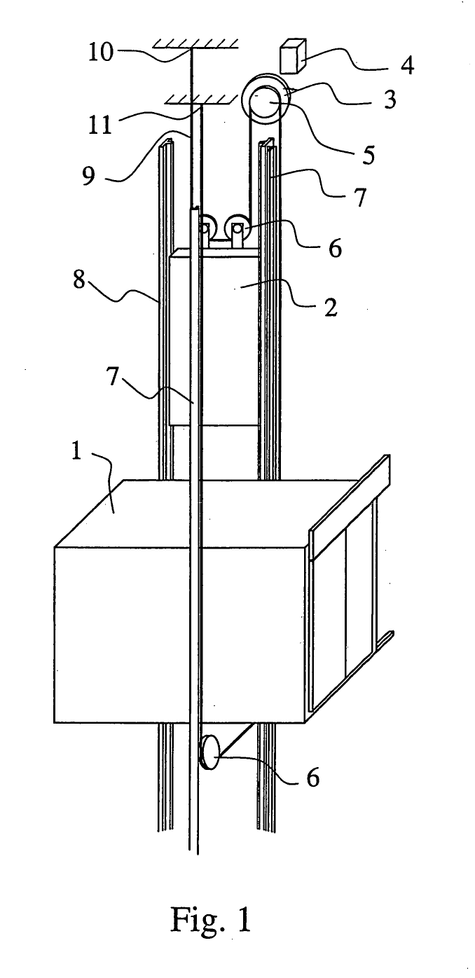

FIG. 1 presents a simplified and oblique top view of an elevator solution applying the invention,

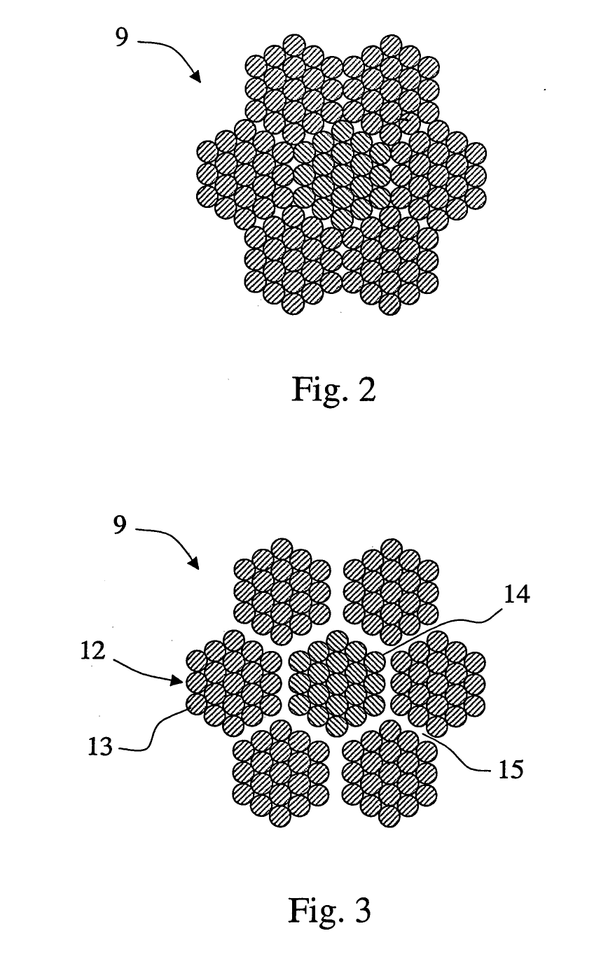

FIG. 2 presents a cross-sectional view of a hoisting rope applicable in the solution of the invention,

FIG. 3 presents a cross-sectional view of the hoisting rope in FIG. 2 in a situation where the rope has been partly untwisted,

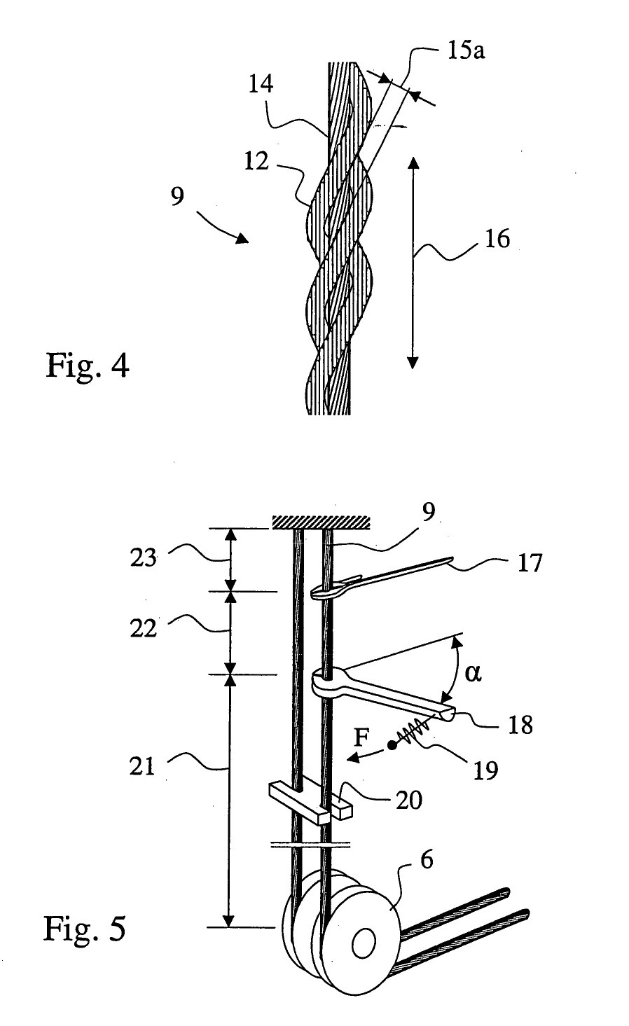

FIG. 4 presents the hoisting rope in a simplified side view in a situation where the rope has been partly untwisted, and

FIG. 5 illustrates an oblique side view of a situation where the tightness of the hoisting rope is being measured.

FIG. 1 presents a typical elevator solution in which the method of the invention for ensuring and measuring the internal tightness of an elevator hoisting rope can be used. The elevator is preferably an elevator without machine room and having a hoisting machine 3 connected via a traction sheave 5 to a set of hoisting ropes, which consists of hoisting ropes 9 running parallel to each other and supporting a counterweight 2 and an elevator car 1 moving on their respective tracks, i.e. along guide rails 8 and 7. The parallel hoisting ropes 9 are anchored to a fixed starting point 10, from which the ropes go downwards towards a diverting pulley 6 mounted in conjunction with the elevator car 1, at a position substantially below the elevator car. From the diverting pulley 6, the hoisting ropes go to a second corresponding diverting pulley placed at the other lower edge of the elevator car and, having passed around this second diverting pulley, they go upwards to the traction sheave 5 of the elevator machine 3 disposed in the in the upper part of the elevator shaft. Having passed around the traction sheave 5 by its top side, the hoisting ropes go again down to diverting pulleys 6 mounted in conjunction with the counterweight 2, passing around these pulleys by their lower side and then returning again up to their fixed end point 11. The functions of the elevator are controlled by a control system 4.

FIGS. 2 and 3 present cross-sectional views of a hoisting rope applicable in the solution of the invention. In the situation represented by FIG. 2, the hoisting rope 9 is in a correct state of tightness, with all its strands tightly twisted according to their braiding around the core strand. FIG. 3 again illustrates a situation where the braiding of the rope has become loose. The figure shows the rope with an exaggerated loosening to provide a sufficient visual impression. As a result of the loosening, the six strands 12 forming the sheath of the rope 9, each of which in this case consists of nineteen wires 13 twisted around each other, have come loose of the core strand 14 forming the core of the rope. As a result of the loosening, there appears both between the strands 12 of the rope sheath and between the sheath strands 12 and core strand 14 a clearance 15, the magnitude of which is not necessarily the same in all parts of the rope. Because of the clearance 15, the contact of the rope strands with each other is diminished, and the effect locking the braiding together is also weakened.

FIG. 4 presents a hoisting rope 9 thus loosened, in side view and simplified for visual clarity. The core strand 14 is straight, but a loosened strand 12 has grown in length in the longitudinal direction 15 of the rope because, due to a diminished contact and interlock between strands, there has also appeared between the twists of the strand 12 a clearance 15a, which has an effect in the longitudinal direction 16 of the rope. The more the braiding of the strand 12 becomes untwisted, the more will the virtual length of the strand increase in the longitudinal direction of the rope. The length is of course at a maximum when the braiding has been straightened completely.

The method of the invention ensures a structural tightness and tension of the hoisting ropes 9 sufficient to keep the rope together, to ensure that after start-up of the elevator there will appear no accumulated looseness that would make the rope susceptible to damage. Sufficient tightness of the rope is ensured at installation time. At the end of the installation operation, when the installation has been finished in other respects, the mutual tightness of all the parallel hoisting ropes 9 is first ensured by equalizing the spring lengths if necessary and performing a sufficient number of equalizing runs if necessary. After the aforesaid operations have been carried out, the second ends of the rope are released from their anchorage and all the hoisting ropes 9 are tightened by twisting them from the free end and over a free straight portion as long as possible in the same direction with the pitch of the rope helix by a number of turns required to achieve a sufficient tightness. This tightening action is continued until the tightening effect is propagated after the straight portion even over the diverting and other pulleys. The required number of turns depends at least on the rope length. For example, in the case of a 7-strand, 4-mm hoisting rope with a pitch of 25 mm, to obtain a sufficient tightness, the rope is twisted by about 0.2 . . . 2 turns/meter of hoisting length, preferably about 0.5 . . . 1.5 turns/meter of hoisting length and most preferably about 0.9 . . . 1.1 turns/meter of hoisting length. More generally, in the case of a 4-mm rope having a hoisting length of 4 m and thus 4000/25=160 pitches, this means that a preferable number of turns is 1 turn per about 320 . . . 100 twist pitches, and thus 1 turn/320 pitches produces a looser rope while 1 turn/100 pitches produces a tighter rope. A suitable tightness is 1 turn/about 180 . . . 150 twist pitches. In most hoisting ropes, a sufficient tightness can be achieved by using values in the range of 1 turn/400 . . . 100 twist pitches. In the above, twist pitch thus refers to the number of rope twists, i.e. twist pitches over the entire hoisting length of the rope. As a final result, a hoisting rope is achieved in which the outer strands 12 forming the rope sheath have a greater tension than the core strand 14 inside the rope. In another embodiment of the invention, it is also possible to use ropes thinner than 4 mm, e.g. ropes with a diameter of about 3 mm or even less. In the case of thinner ropes, it is possible to use ropes having a number of twists larger than the numbers mentioned above.

In practice, the required number of tightening turns need not necessarily be calculated in the manner described above. A sufficient tightness can be easily measured by a suitable measuring procedure. FIG. 5 visualizes a measuring method according to the invention, which is suited to this purpose and guarantees a sufficient tightness. The figure is depicted in a simplified form and is not in scale. By the measuring method of the invention, the torque produced by the tightening tension of the rope 9 is measured. The measurement is carried out after the hoisting ropes 9 have been first tightened after installation to a substantially equal tightness and after a few equalizing runs have been performed to allow the tension differences between different parts of the rope to be equalized. The measurement can be made from different points in the longitudinal direction of the ropes. Based on the measurement results, the rope is tightened further if necessary to achieve a sufficient tightness.

For the measurement, a constant distance must be allowed for the rope 9 as a straight free length 21 of the rope. This distance is suitably e.g. 3 m. In the figure, we can assume that the distance 21 from the torsion moment measuring clamp 18 to the diverting pulley 6 is at least the required free length 3 m. Correspondingly, the measuring length 22 chosen to be used here is 0.5 m or 500 mm. The measuring length 22 is the distance from the torsion moment measuring clamp 18 to a holding clamp 17, by means of which the rope 9 is locked so that it cannot be twisted in the portion 23 above the holding clamp 17. In addition, a rope separator 20 must be placed between the rope to be measured and the adjacent ropes to provide a measuring space of required size. Parallel thin ropes lie very close to each other, in which case the horizontal distance between the ropes has to be increased to permit the jaws of the torsion moment measuring clamp 18 to be placed around the rope to be measured.

The measurement is carried out by holding the rope in place by means of the holding clamp 17 and turning the torsion moment measuring clamp 18 provided with a scales 19 through a constant twist angle • in the direction of the rope helix, i.e. in the twisting direction of the braiding. After this turning movement, the scales 19 of the torsion moment measuring clamp 18 will show the force F used to turn the clamp, this force being always the same for identical ropes at the same level of tightness. In the figure, the scales structure 19 is depicted in a diagrammatic form.

The embodiments of the invention are not necessarily restricted to any embodiment described above but different embodiments can be combined partly or completely within the framework of technical requirements. Likewise, parts of different embodiments can be used to form embodiments according to the basic idea of the invention which are not presented here.

It is obvious to the person skilled in the art that the invention is not limited to the examples described above, but that it may be varied within the scope of the claims presented below. Thus, the size and structure of the elevator hoisting ropes used as well as the required number of tightening turns may differ from those mentioned above. Likewise, the measurement of a sufficient torsion moment can be carried out using instruments and values differing from those described above.

1. Method for ensuring the internal tightness of an elevator hoisting rope in an elevator provided with hoisting ropes, wherein each hoisting rope is tightened after installation of the elevator to a desired tightness by twisting the rope by the required number of turns in the twisting direction of the braiding, in such manner that the first end of the rope remains fastened to its an chorage while the second end of the rope is free so as to allow tightening.

2. Method according to claim 1, wherein the tightening of the rope is accomplished by twisting the rope from its free end, in which rope a straight portion as long as possible starting from the free end has been provided, and continuing the twisting action so that the tightening effect is propagated after the straight portion over the diverting and other pulleys to the entire rope.

3. Method according to claim 1, wherein the tightening of the rope is effected by twisting the rope in the twisting direction of the braiding by substantially about 1 turn/N twist pitches, where hi is preferably in the range of about 320 . . . 100.

4. Method according to claim 1, wherein the tightening of the rope is effected by twisting the rope in the twisting direction of the braiding by substantially about 1 turn/N twist pitches, where N is preferably in the range of about 180 . . . 150.

5. Method according to claim 1, wherein the tightening of the rope is effected by twisting the rope in the twisting direction of the braiding by substantially about M turns/meter of hoisting length, where M is in the range of about 0.2 . . . 0.2, preferably about 0.5 . . . 1.5 and very advantageously about 0.9 . . . 1.1.

6. Method according to claim 1, wherein the tightening of the rope is effected by re-tightening the rope after installation and equalization runs, in such manner that that, after the tightening operation, the tension in the sheath strands forming the sheath of the rope is greater than in the core strand inside the rope.

7. Method according to claim 1, wherein the measurement of the required tightness is made by locking a torsion device, such as a torsion moment measuring clamp, onto the rope at the point of measurement and turning the torsion device in the twisting direction of the braiding of the rope through a constant twist angle (•) and then measuring the moment needed for the turning movement by means of a measuring device, such as a scales.

8. Method according to claim 7, wherein the torsion moment measuring clamp is locked onto the rope so that on one side of the clamp there remains at least a pre-selected constant straight free length of the rope while on the other side of the clamp there remains in the rope a pre-selected straight measurement length, on the other side of which there correspondingly remains a rope portion locked in place so that is not twisted.

9. Elevator provided with hoisting ropes, wherein each hoisting rope of the elevator has been re-tightened so that the tension in the sheath strands forming the sheath of the rope is greater than in the core strand inside the rope.
